(19) United States
(12) Patent Application Publication
(10) Pub. No.: US 2009/0097943 A1
(43) Pub. Date: Apr. 16, 2009

(54) Distorted nut with an arrow shaped end

(76) Inventor: Roland Eugene Scott, Los Angeles, CA (US)

Correspondence Address: Roland E. Scott, 1128 W. 37th Place, Los Angeles, CA, 90007, US

(21) Appl. No.: 11/891,089

(22) Filed: Oct. 15, 2007

(51) Int. Cl. F16B 37/00; F16B 39/28

(52) U.S. Cl. 411/427

(57) ABSTRACT

Normally, when assembling trucks to a skateboard, a screw and a nut are used to mount it to the skateboard. The assembly requires two tools, a screw driver and socket wrench, which are used to tighten the skate trucks to the board. The purpose of my invention is to eliminate the use of the socket wrench. Lockdown is a specially designed nut with an arrow like end that serves to keep the nut from rotating when tightening the skate trucks to the board, which eliminates the socket wrench. This is how the process works, the nut with the aid of its arrow like end, butts up against the truck and prevents it from rotating. Normally with a regular nut, you would need a socket wrench to keep the nut from rotating. With lockdown the process eliminates the need for a socket wrench thereby making the installation faster and efficient.

### CROSS-REFERENCE TO RELATED APPLICATIONS

Not Applicable.

### STATEMENT REGARDING FEDERALLY SPONSORED RESEARCH OR DEVELOPMENT

Non Applicable.

### REFERENCE TO SEQUENCE LISTING, A TABLE, OR A COMPUTER PROGRAM LISTING COMPACT DISC APPENDIX

Non Applicable.

### BACKGROUND OF INVENTION

In my years of skateboarding, I have cracked many skateboards and was under pressure, especially during competitions and special skateboarding events to change the skateboard trucks as quickly as possible, in order to participate without forfeiting my turn in the competition. It was becoming a hassle to carry tools with me everywhere I went, and very time consuming to switch the trucks from the broken one onto a new one. I wanted to come up with something that could reduce the amount of tools needed and to expedite the time it takes to mount skateboard trucks to a skateboard. My invention will eliminate the need to carry so many tools and will reduce the amount of time required to mount skateboard trucks to a skateboard for everyone in the field of skateboarding.

Normally when fastening a bolt and nut to mount a skateboard truck to a skateboard you need two tools, a screw driver and socket wrench. This is why I invented the distorted nut with an arrow shaped end, so that a skater can eliminate the use of one of the tools needed. The modified nut is a distorted nut with an arrow shaped end on the outside of the nut's wall. The nut's arrow shaped end acts as a tool in itself and therefore a bolt can be tightened down with a simple screw driver. With a regular nut a person would need a socket wrench to hold the nut from circling. This is how my invention eliminates the socket wrench and saves time.

This is how the process works; when a skater is mounting a skateboard truck to their skateboard we need bolts and nuts. The bolt is placed through the skateboard and the nut is placed on the skateboard truck. The nut, with its arrow shaped end butts up against the wall of the skateboard truck and is stopped from circling in the process of tightening. Normally, with a regular nut, you would need a socket wrench to prevent the nut from circling in the tightening process of the bolt and nut. The distorted nut with an arrow shaped end is able to prevent itself from circling; the last step would be to tighten down the bolt with a screw driver. Therefore, the distorted nut with an arrow shaped end makes the process of mounting a skateboard truck to a skateboard much easier, faster, efficient, and with less tools.

### BRIEF SUMMARY OF THE INVENTION

The distorted nut with its arrow shaped end is an invention for skateboards, which will benefit skateboarders, skateboard shops, and those who assemble skateboards. The distorted nut with an arrow shaped end is designed to eliminate the reliance upon a socket wrench, which is used to keep the nut in place when tightening the skateboard trucks to the skateboard. What the distorted nut with an arrow shaped end does is it butts up against the wall of the truck preventing it from moving when mounting skateboard trucks to a skateboard. As a result a skateboarder saves time when assembling a board. Therefore the process of assembling boards has become easier and more efficient for all of those in the skateboarding sport, business, and industry.

### BRIEF DESCRIPTION OF THE SEVERAL VIEWS OF THE DRAWING

I, Roland Scott, have invented a new design (a distorted nut with an arrow shaped end) to fasten skateboard trucks to a skateboard when mounting, as set forth in the following specification.

FIG. 1 is a top view of the distorted nut with an arrow shaped end on top of the base plate of the skateboard truck with its arrow shaped end against skateboard truck wall.

FIG. 2 is a top and left side view of the distorted nut with an arrow shaped end in its entirety.

FIG. 3 is a top and right side view of the distorted nut with an arrow shaped end in its entirety.

FIG. 4 is a top and front view of the distorted nut with an arrow shaped end in its entirety.

FIG. 5 is a top view of the distorted nut with an arrow shaped end in its entirety.

FIG. 6 is a top and back view of the distorted nut with an arrow shaped end in its entirety.

FIG. 7 is bottom view of the distorted nut with an arrow shaped end in its entirety.

FIG. 8 is a view of a skateboard depicting two skateboard trucks affixed with regular nylon nuts set in place to hold the skateboard trucks to the board.

FIG. 9 is a side view depicting a portion of a skateboard in an upright position, directly beneath is a skateboard truck mounted to the board, displaying two of four distorted nuts with arrow shaped end installed in position.

I claim: the design of the distorted nut with an arrow shaped end for a skateboard as shown.

### DETAIL DESCRIPTION OF THE INVENTION

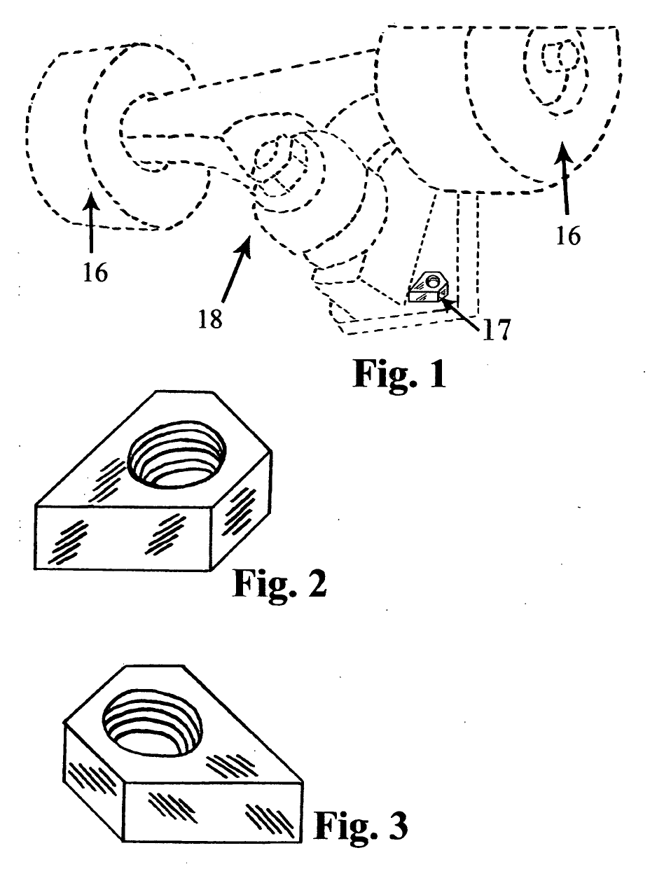

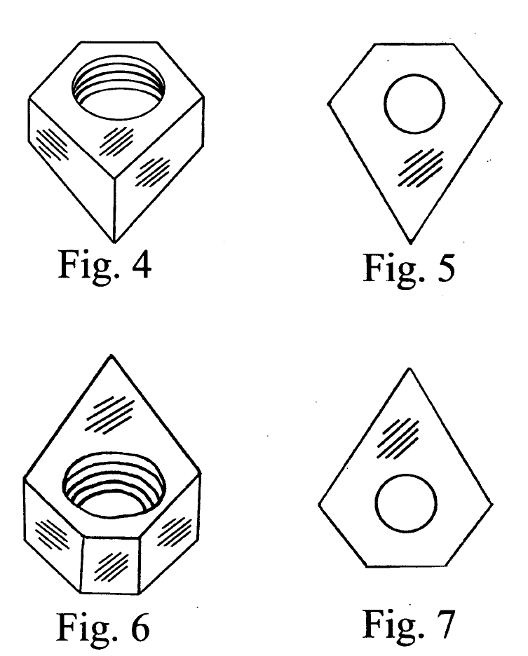

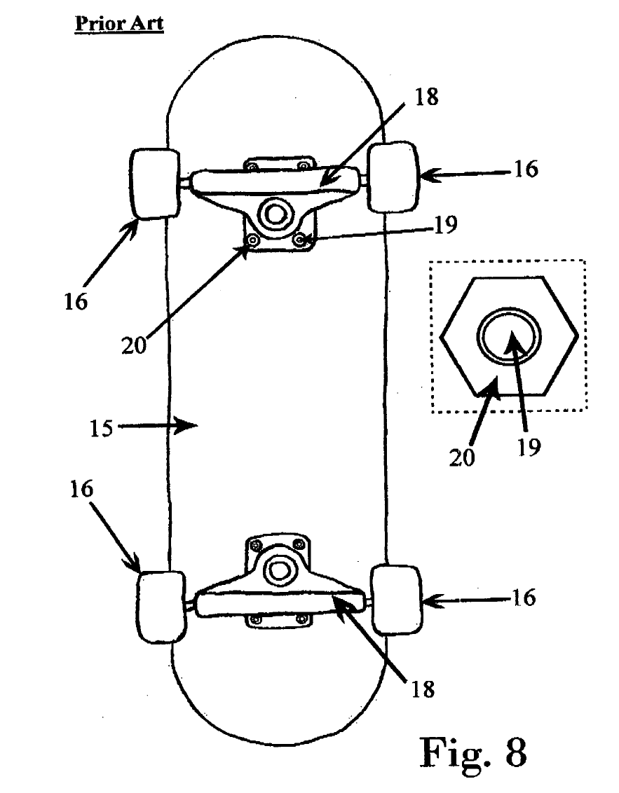

The distorted nut with an arrow shaped end 17 as shown in FIG. 2 is designed to eliminate the use of two tools when assembling skateboard trucks 18 to a skateboard 15. Normally when assembling skateboard trucks 18 to a skateboard 15 two tools are used, the first tool is a philip screw driver and the second is a ⅜^{th} socket wrench. Originally the socket wrench deters the nut from circling when mounting skateboard trucks 18 to a board 15 and the philip screw driver is used to tighten the screw 19 to the nut 20 as shown in FIG. 8. The distorted nut with an arrow shaped end 17 as shown in FIG. 1, was designed to eliminate the need for a ⅜^{th} socket wrench. The distorted nut has an arrow shaped end 17 as shown in FIG. 1 that butts up against the skateboard truck 18, deterring it from circling thereby acting as a tool in itself and making the installation more efficient, user friendly, and less time consuming. Normally when mounting skateboard trucks 18 to a skateboard 15 it takes on average twenty minutes, but with the distorted nut with an arrow shaped end 17 as shown in FIG. 2, the time is cut in half because one of the tools is no longer required for installation; Which becomes effective especially in a skateboard competition or event, where time is of the essence and must be utilized efficiently.

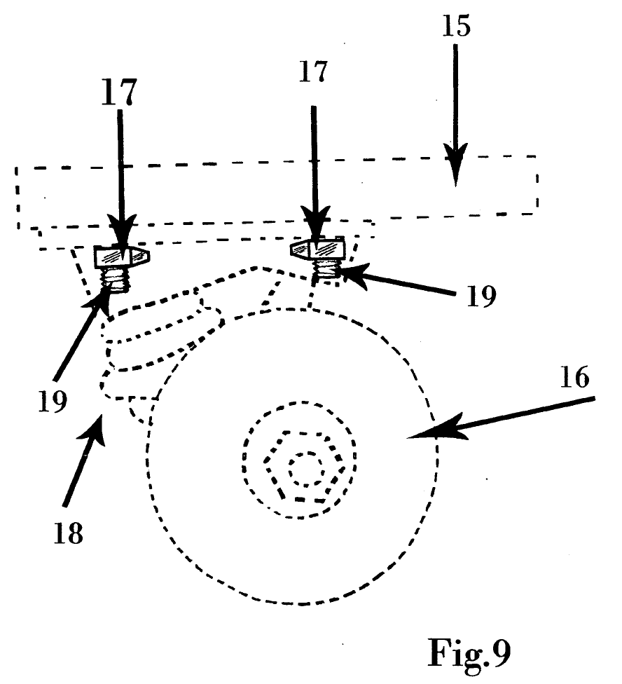

In the skateboard industry the skateboard requires two skateboard trucks 18 as shown in FIG. 8. In order to mount the skateboard trucks 18 to the board 15, as shown in FIG. 8, four bolts 19 and four regular nylon nuts 20 are required for each truck 18, as shown in FIG. 8, which without would be impossible for a skateboarder to skate. Originally to mount these bolts 19 and nuts 20, two tools are required. With the distorted nut with an arrow shaped end 17 as shown in FIG. 1 eliminates the need for a socket wrench by butting up against the wall of the skateboard truck as shown in FIG. 1, therefore, the assembling process becomes more efficient and less time consuming. The distorted nut with an arrow shaped end 17 is designed to butt up against the wall of the truck as shown in FIG. 1, preventing the distorted nut with an arrow shaped end 17 from circling when tightening the bolt 19 down. This invention will enhance the assembling process of skateboards by eliminating the need for a socket wrench when assembling distorted nuts 17 and bolts 19 to mount skateboard trucks 18 to a skateboard 15 as shown in FIG. 9.

1. A distorted nut comprising: an arrow shaped end, said end designed to eliminate the need of one tool when mounting skateboard trucks to a skateboard.
